(19) United States
(12) Patent Application Publication
(10) Pub. No.: US 2009/0177826 A1
(43) Pub. Date: Jul. 9, 2009

(54) SYSTEM AND METHOD FOR PREEMPTIVE MASKING AND UNMASKING OF NON-SECURE PROCESSOR INTERRUPTS

(75) Inventors: Gregory R. CONTI, Saint Paul (FR); Steven C. GOSS, Antibes (FR)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/971,253

(22) Filed: Jan. 9, 2008

(51) Int. Cl. G06F 13/24

(52) U.S. Cl. 710/262

(57) ABSTRACT

The present disclosure describes systems and methods for preemptive masking and unmasking of non-secure processor interrupts. At least some embodiments provide a system that includes a processor capable of operating in a non-secure mode, and preemption logic coupled to the processor (the preemption logic capable of asserting an interrupt signal to the processor). If the processor is operating in the non-secure mode, the preemption logic preemptively inhibits a non-secure assertion of the interrupt signal in response to a mask event. If the processor is operating in the non-secure mode, the preemption logic preemptively enables the non-secure assertion of the interrupt signal in response to an unmask event.

### BACKGROUND

Mobile electronic devices such as personal digital assistants (PDAs) and digital cellular telephones are being increasingly used for electronic commerce (e-commerce) and mobile commerce (m-commerce). Programs that execute on such mobile devices to implement e-commerce and/or m-commerce functionality may need to operate in a secure mode to reduce the likelihood of attacks by malicious programs (e.g., virus programs) and to protect sensitive data.

For security reasons, at least some processors provide two levels of operating privilege: a first level of privilege for user programs; and a higher level of privilege for use by the operating system. However, the higher level of privilege may or may not provide adequate security for m-commerce and e-commerce, given that this higher level relies on proper operation of operating systems with highly publicized vulnerabilities. In order to address security concerns, some mobile equipment manufacturers implement yet another third level of privilege, or secure mode, that places less reliance on corruptible operating system programs, and more reliance on hardware-based monitoring and control of the secure mode. An example of one such system may be found in U.S. Patent Publication No. 2003/0140245, entitled “Secure Mode for Processors Supporting MMU and Interrupts.”

In addition to this secure mode, various hardware-implemented security firewalls and other security monitoring components have been added to the processing systems used in mobile electronic devices to further reduce the vulnerability to attacks. Examples of these security improvements may be found in U.S Patent Publications No. 2006/0015947, entitled “System and Method for Secure Mode for Processors and Memories on Multiple Semiconductor Dies Within a Single Semiconductor Package,” No. 2006/0004964, entitled “Method and System of Ensuring Integrity of a Secure Mode Entry Sequence,” No. 2006/0021035, entitled “System and Method of Identifying and Preventing Security Violations Within a Computing System,” No. 2006/0005072, entitled “Method and System of Verifying Proper Execution of a Secure Mode Entry Sequence,” and European Patent Application EP 04292405.0, entitled “Method and System for Detecting a Security Violation Using an Error Correction Code,” all of which are hereby incorporated by reference.

At least some hardware-implemented security measures that are used to control access to mobile electronic devices include solutions that take an “all or nothing” approach, wherein access to a particular function or hardware element of the device is either granted in its entirety, or denied in its entirety. This approach tends to impose a trade-off in the design of such systems, wherein the security of a mobile electronic device is balanced against its flexibility. This trade-off becomes significant when one considers that mobile electronic devices have begun to incorporate the types of high-level operating systems previously more commonly found in home computers. Features that make such high-level operating systems an attractive alternative may become limited or unavailable due to security constraints that restrict access to selected functions or hardware elements on an all or nothing basis.

### SUMMARY

Accordingly, there are disclosed herein systems and methods for preemptive masking and unmasking of non-secure processor interrupts, said masking and unmasking occurring in response to one or more masking and unmasking events respectively.

### BRIEF DESCRIPTION OF THE DRAWINGS

For a detailed description of exemplary embodiments of the invention, reference will now be made to the accompanying drawings in which:

FIG. 1 shows a computing system constructed in accordance with one or more illustrative embodiments;

FIG. 2 shows a multi-processing unit (MPU) subsystem and a security monitoring subsystem, constructed in accordance with one or more illustrative embodiments;

FIG. 3 shows a detailed block diagram of interrupt logic used within an MPU subsystem, constructed in accordance with one or more illustrative embodiments; and

FIG. 4 shows a flow chart of a method for preemptively masking and unmasking a non-secure assertion of an interrupt, in accordance with one or more embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more parts and may be used to refer to a computer system or a portion of a computer system. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Inasmuch as the systems and methods described herein were developed in the context of a mobile computing system, the description herein is based on a mobile computing environment. However, the discussion of the various systems and methods in relation to a mobile computing environment should not be construed as a limitation as to the applicability of the systems and methods described herein to only mobile computing environments. One of ordinary skill in the art will appreciate that these systems and methods may also be implemented in other computing environments such as desktop computers, laptop computers, network servers, and mainframe computers, just to name a few examples.

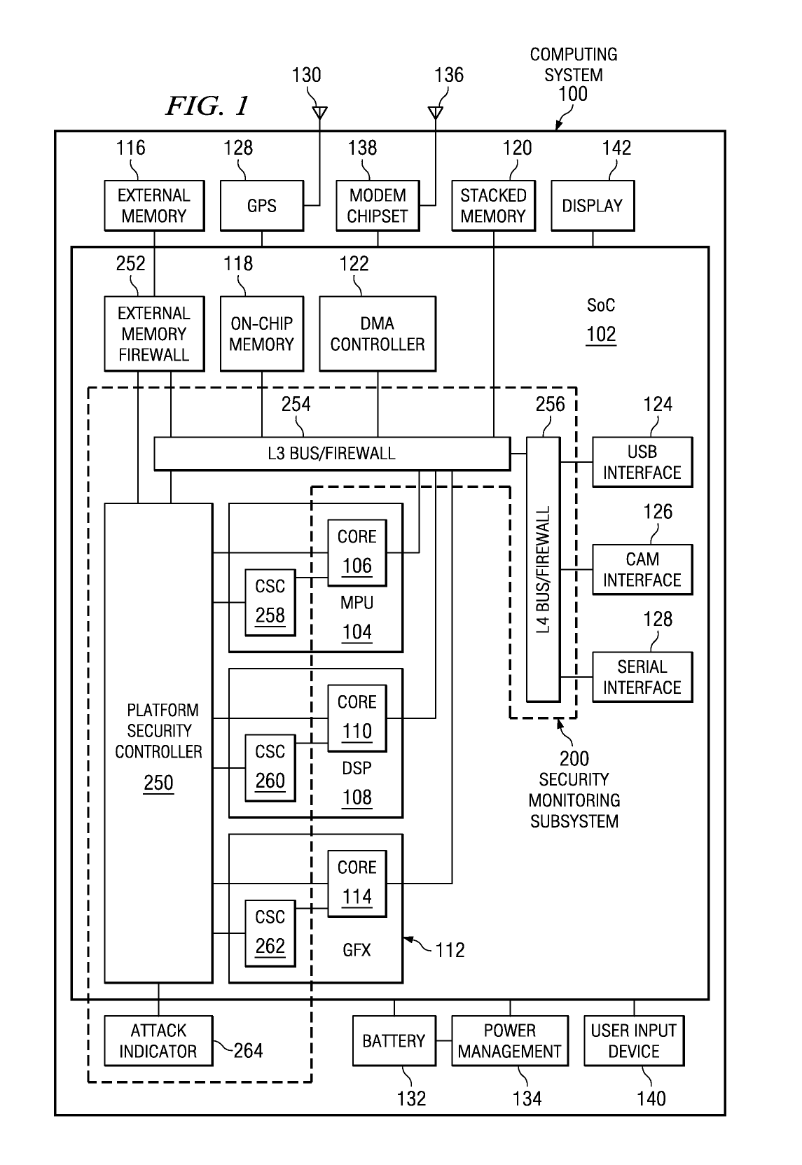

FIG. 1 shows a computing system 100 constructed in accordance with one or more embodiments of the invention. In accordance with at least some embodiments, the computing system 100 may be a mobile device such as a cellular telephone, personal digital assistant (PDA), text messaging system, and/or a device that combines the functionality of a messaging system, personal digital assistant and a cellular telephone. The computing system 100 includes a multiprocessing unit (MPU) 104 coupled to various other system components by way of data and instruction busses and security firewalls (e.g., L3 bus/firewall 254, and L4 bus/firewall 256). The MPU 104 includes a processor core 106 that executes programs. In some embodiments, the core 106 has a pipelined architecture. The MPU 104 further includes a core security controller (CSC) 258, which aids the MPU 104 in entering a secure mode for execution of secure programs on the core 106. The core security controller 258 may also monitor operation during a secure mode to ensure secure operation, and during a non-secure or public mode to prevent access to secure components of the computing system 100.

The core 106 may be any processor suitable for integration into a system on a chip (SoC), such as the ARM® 1136 series of processors. In other embodiments, the core 106 may be a processor that includes some or all of the functionality of the core security controller 258 as described herein, such as the ARM® 1176 series of processors. The ARM® 1136 and 1176 technology may be obtained from ARM® Holdings plc of Cambridge, United Kingdom, and/or ARM®, Inc. of Austin, Tex., USA.

The computing system 100 also includes a digital signal processor (DSP) 108 coupled to the MPU 104 by way of the L3 bus/firewall 254. The DSP 108 aids the MPU 104 by performing task-specific computations, such as graphics manipulation and speech processing. The DSP 108 has its own core 110 and its own core security controller 260. A graphics accelerator (GFX) 112 also couples to both the MPU 104 and the DSP 108 by way of the L3 bus/firewall 254. The graphics accelerator 112 performs necessary computations and translations of information to allow display of information, such as on display device 142. The graphics accelerator 112, like the MPU 104 and the DSP 108, may have its own core 114 and its own core security controller 262. As with the MPU 104, both the DSP 108 and the graphics accelerator 112 may each independently enter a secure mode to execute secure programs on their respective cores.

The computing system 100 also includes a direct memory access controller (DMA CTLR) 122 coupled to on-chip memory 118, external memory 116 (via external memory firewall 252), and stacked memory 120 by way of the L3 bus/firewall 254. The direct memory access controller 122 controls access to and from the on-chip memory and the external memory by any of the other system components such as, for example, the MPU 104, the DSP 108 and the graphics accelerator 112. The memory components may be any suitable memory, such as synchronous RAM, RAMBUS® type of RAM, programmable ROMs (PROMs), erasable programmable ROMs (EPROMs), and electrically erasable programmable ROMs (EEPROMs). The stacked memory 120 may be any suitable memory that is integrated within the same semiconductor package as system-on-a-chip (SoC) 102, but on a semiconductor die separate from the semiconductor die of the system-on-a-chip 102.

The computing system 100 also includes various interfaces and components coupled to the various subsystems of the SoC 102 by way of the L4 bus/firewall 256. The interfaces include a USB interface (USB I/F) 124 and a serial interface (Serial I/F) 128 that each allows the computing system 100 to couple to and communicate with external devices, such as user input device 140. User input device 140 may include such devices as a keyboard, keypad, mouse, and/or touch panel, through which a user may input data and/or messages. The interfaces also include a camera interface (CAM I/F) 126, which enables camera functionality for capturing digital images. Components that also couple to the SoC 102 by way of the L4 bus/firewall 256 include a modem chipset 138 coupled to an antenna 136, a global positioning system (GPS) circuit 128 likewise coupled to an antenna 130, and a power management unit 134 controlling a battery 132 that provides power to the various components of the computing system 100.

Many of the components illustrated in FIG. 1, while also available as individual integrated circuits, may be integrated or constructed onto a single semiconductor die. Thus, the MPU 104, digital signal processor 108, and direct memory access controller 122, along with some or all of the remaining components, may be integrated onto a single die, and thus may be integrated into the computing system 100 as a single packaged component. Having multiple devices integrated onto a single die, especially devices comprising an MPU 104 and on-chip memory (e.g., on-chip memory 118), is generally referred to as a system-on-a-chip (SoC) 102 or a megacell. While using a system-on-a-chip may be preferred, obtaining the benefits of the systems and methods as described herein does not require the use of a system-on-a-chip.

Each of the core security controllers (e.g., core security controller 258) of the illustrative embodiment of FIG. 1 is implemented as a hardware-based state machine that monitors system parameters of each of the respective processor cores (e.g., core 110). A core security controller allows the secure mode of operation to initiate such that a processor may execute secure programs from secure memory (e.g., from a secure address range of the on-chip memory) and access secure resources (e.g., control registers for secure channels of the direct memory access controller 122). For more detailed description of embodiments of a core security controller, including the secure mode of operation, the signals that may be monitored to make the decision as to whether to enter the secure mode, and a state diagram for operation, reference may be had to United States Patent Application Publication No. 2003/0140245A1, published Jul. 24, 2003, which is assigned to the same Assignee as the present specification, and which is incorporated by reference herein as if reproduced in full below.

The L3 bus/firewall 254 and the L4 bus/firewall 256 of the computing system 100 each include busses linking the various components of the computing system 100 and security firewalls that provide additional protection beyond the protection provided by the core security controllers. The security firewalls provide isolation between components of the computing system 100 that are capable of operating at different security levels. The security firewalls are integrated into the busses that link the various components of the computing system 100, thus providing the ability to monitor control the request/response mechanisms within the busses. Such request/response mechanisms allow components requesting access (i.e., initiators) to access other components, (i.e., targets) only if access is allowed by the security firewall integrated into the bus coupling the components. Thus, for example, the direct memory access controller 122 may request access to the stacked memory 120, but will only be granted access by the L3 bus/firewall 254 if access does not violate a security constraint (i.e., has the appropriate access attributes as defined in the memory security firewall). Or, if an attempt is made by a USB device coupled to the USB port 124 to access a secure address range of the on-chip memory 118, the L4 bus/firewall 256 may deny access.

The security firewalls, the core security controllers (e.g., core security controller 262), and the attack indicator 264 each couple to the platform security controller 250. The platform security controller 250 acts as a hub for the detection of security violations, detecting security violation signal assertions from the core security controllers and the firewalls. If the platform security controller 250 detects an assertion of a security violation signal, it may respond by alerting the user that a violation has been detected, such as by activating the attack indicator 264, by causing one or more core security controllers (e.g., core security controller 258) to initiate one or more security response sequences, such as preventing an initiator from accessing the target memory or component, and/or by logging the source of the security violation. The attack indicator 264 may be a visible or audible (or both) indicator such as an LED or a buzzer.

The response of the platform security controller 250 is determined based on pre-selected options set when the computing system 100 is booted, and/or based on the source of the security violation signal assertion (e.g., a firewall). For example, if a firewall has already blocked an attempted illegal access, the platform security controller 250 may simply log the fact that the security violation occurred as no further action is needed. Exemplary embodiments of computer systems including a security controller, firewalls, and core security controllers are provided in US Patent Publication No. 2006/0021035, entitled “System and Method of Identifying and Preventing Security Violations within a Computing System,” which is hereby incorporated by reference.

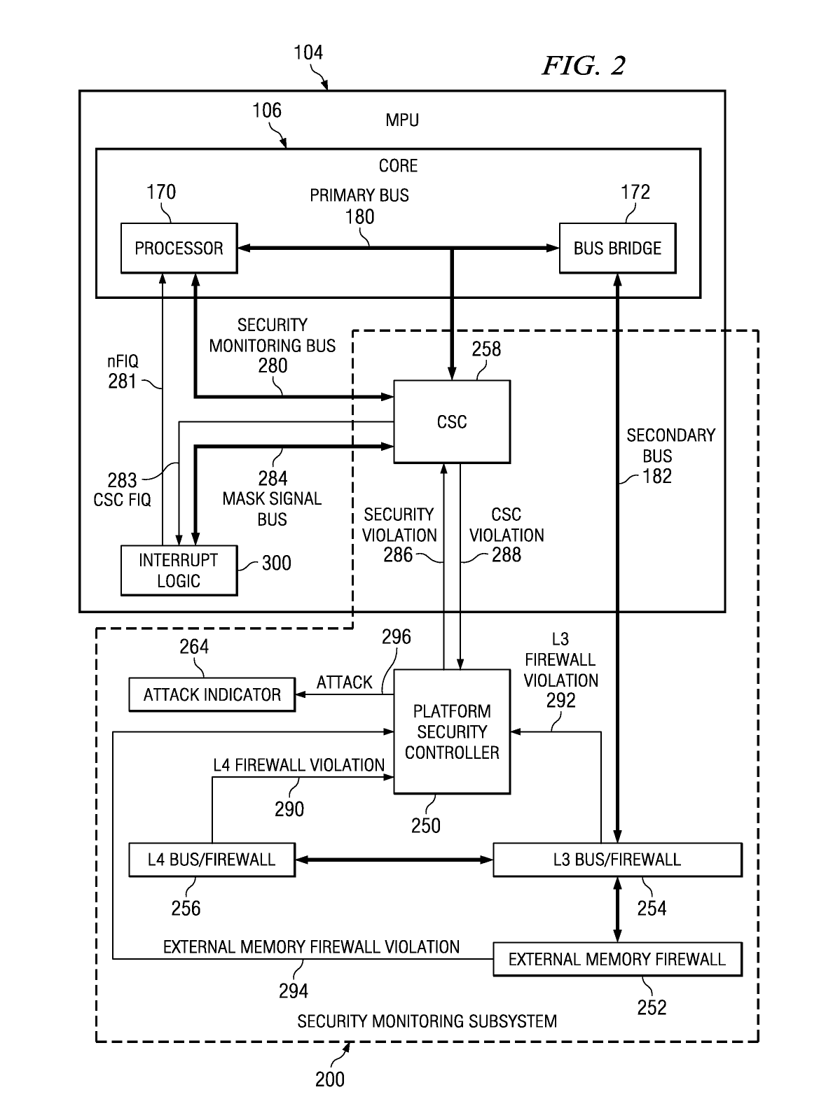

The various security components described operate as security monitoring system 200, which comprises the platform security controller 250, bus/firewalls 252, 254 and 256, core security controllers 258, 260 and 262, and attack indicator 264. FIG. 2 illustrates security monitoring system 200 in greater detail, depicting an illustrative configuration that couples components within monitoring system 200 to components within MPU 104. MPU 104, in accordance with at least some illustrative embodiments, comprises core 106, interrupt logic 300, secondary bus (2nd Bus) 182, security monitoring bus (Sec Mon Bus) 280, mask signal bus (Mask Sig Bus) 284, and core security controller (CSC) 258 (overlapping with security monitoring system 200, which also comprises core security controller 258). Core 106 comprises processor 170, primary bus 180 (the native bus of processor 170), and bus bridge 172. Processor 170, in accordance with at least some illustrative embodiments, may be any processor suitable for integration into a system on a chip, such as the ARM® series of processors.

Processor 170 couples through primary bus 180 to bus bridge 172, which provides for signal conversions between primary bus 180 and secondary bus 182. Bus bridge 172 couples through secondary bus 182 to the various busses and firewalls throughout the system 100 of FIG. 1, thus allowing processor 170 to communicate with the various elements of system 100 previously described. Continuing to refer to FIG. 2, core security controller 258 also couples to processor 170 and bus bridge 172 through primary bus 180, which allows core security controller 258 to monitor the signals presented on primary bus 180. By monitoring these signals, core security controller 258 can detect conditions on the primary bus 180 that are indicative of a security violation, and take corrective action as previously described. This includes, for example, signaling the platform security controller 250 via CSC violation signal 288. Core security controller 258 may also take corrective action based upon an indication from platform security controller 250, provided via security violation signal 286.

Platform security controller 250 also detects security violation signal assertions initiated by other elements of the security monitoring system 200. These assertions include assertions of L3 firewall violation signal 292 (generated by L3 bus/firewall 254); assertions of L4 firewall violation signal 290 (generated by L4 bus/firewall 256); and assertions of external memory firewall violation signal 294 (generated by external memory firewall 252). Attack signal 296 is asserted in response to a security violation by platform security controller 250, and the assertion is acted upon by attack indicator 264, which provides a visual and/or audible notification to a user of the system 100 that an attack has occurred.

Core security controller 258 couples to interrupt logic 300 via mask signal bus 284, allowing core security controller to control preemptive masking and unmasking of at least some interrupts assertions that are detected by interrupt logic 300 and forwarded as one or more interrupts to processor 170 (e.g., fast interrupt request (nFIQ) signal 281). Core security controller 258 may also cause interrupt logic 300 to generate such an interrupt signal by asserting control signals monitored by interrupt logic 300, such as CSC FIQ 283. Core security controller 258 of the illustrative embodiment of FIG. 2 further couples to processor 170 through security monitor bus 280, which provides additional security related indications from processor 170 to core security controller 258. These indications include the current security configuration and security mode of the processor 170, and whether the processor is attempting to mask or unmask one or more interrupts. The security modes of the processor 170 include a non-secure mode for normal operation; a secure mode for executing code and accessing resources requiring security; and a transitional or monitor mode for determining whether the processor 170 should enter a secure or non-secure mode based on the security designation of the code to be executed.

Just as individual hardware elements are designated as either secure or non-secure resources, assertions of interrupts that can be forwarded to the processor 170 also are designated as either secure or non-secure interrupt assertions. In the illustrative embodiment of FIG. 2, the processor 170 is configured for secure processing of assertions of nFIQ signal 281, which is generated by interrupt logic 300. When processor 170 is configured for such secure processing, an assertion of nFIQ signal 281 causes the processor 170 to enter into the monitor mode of operation. Monitor mode is entered prior to transitioning to a mode consistent with the security classification of the resource that initiated the nFIQ assertion, and of the code executed to service the interrupt assertion. In this manner, transitions in or out of a secure mode of operation in response to the nFIQ assertion are controlled within a mode (monitor mode) that is itself secure.

As already noted, the resource within the system 100 that causes the nFIQ assertion has its own security classification and may be either secure or non-secure. Further, the assertion initiated by a resource (either secure or non-secure) can occur while the processor is in either a secure or non-secure mode of operation. As a result, there are four possible circumstances under which an nFIQ assertion can occur: 1) an nFIQ assertion initiated by a non-secure resource while the processor is in a non-secure mode of operation; 2) an nFIQ assertion initiated by a non-secure resource while the processor is in a secure mode of operation; 3) an nFIQ interrupt assertion initiated by a secure resource while the processor is in a secure mode of operation; and 4) an nFIQ assertion initiated by a secure resource while the processor is in a non-secure mode of operation.

When a non-secure resource initiates an nFIQ assertion while the processor is in a non-secure mode, the processor 170 switches to the monitor mode of operation and processing of the interrupt begins. Upon determining that the assertion is a non-secure assertion within a non-secure mode, and thus that no transition from secure to non-secure or non-secure to secure mode is required, control is transferred to a non-secure interrupt service routine based upon an interrupt vector stored in non-secure memory.

When a non-secure resource initiates an nFIQ assertion while the processor is in a secure mode, the processor 170 switches to a monitor mode of operation in response to the nFIQ assertion. Upon determining that the nFIQ assertion was initiated by a non-secure resource while the processor is operating in a secure mode, all functions necessary to transition securely from a secure mode of operation to a non-secure mode of operation are preformed within system 100. Once the transition preparation is complete, the processor transitions to a non-secure mode of operation, and control is transferred to a non-secure interrupt service routine based upon an interrupt vector stored in non-secure memory.

When a secure resource initiates an nFIQ assertion while the processor 170 is in a secure mode of operation, the processor switches to a monitor mode of operation and processing of the interrupt begins. Upon determining that the nFIQ assertion was initiated by a secure resource within a secure mode, and thus that no transition from secure to non-secure or non-secure to secure mode is required, control is transferred to a secure interrupt service routine based upon an interrupt vector stored in secure memory.

When a secure resource initiates an nFIQ assertion while the processor is in a non-secure mode, the processor 170 switches to a monitor mode of operation in response to the FIQ interrupt. Upon determining that the nFIQ assertion was initiated by a secure resource while the processor is operating in a non-secure mode, all functions necessary to transition securely from a non-secure mode of operation to a secure mode of operation are performed within system 100 (FIG. 1). As with the transition from a secure mode to a non-secure mode, once the transition preparation is complete, the processor transitions to a secure mode of operation, and control is transferred to a secure interrupt service routine based upon an interrupt vector stored in secure memory.

In each of the four cases described, an interrupt service routine is eventually invoked as a result of an nFIQ assertion. When the assertion is initiated by a non-secure resource, a corresponding interrupt service routine is executed in a non-secure mode of operation. Likewise, when the nFIQ assertion is initiated by a secure resource, the interrupt service routine that is executed performs its designated tasks in a secure mode of operation. As with many interrupts, assertions of the nFIQ signal 281 can be masked within the processor 170 by setting one or more bits in a control register (e.g., the current processor status register of an ARM® series processor). But when processor 170 is configured to provide secure processing of nFIQ assertions, masking of nFIQ assertions using a control register within processor 170 may only be performed while operating in a secure mode. This prevents non-secure programs executing on processor 170 from interfering with nFIQ assertions initiated by secure resources. Although it is desirable for security reasons to prevent non-secure programs from masking nFIQ assertions initiated by secure resources, it is still desirable to allow non-secure programs to separately mask nFIQ interrupt assertions initiated by non-secure resources.

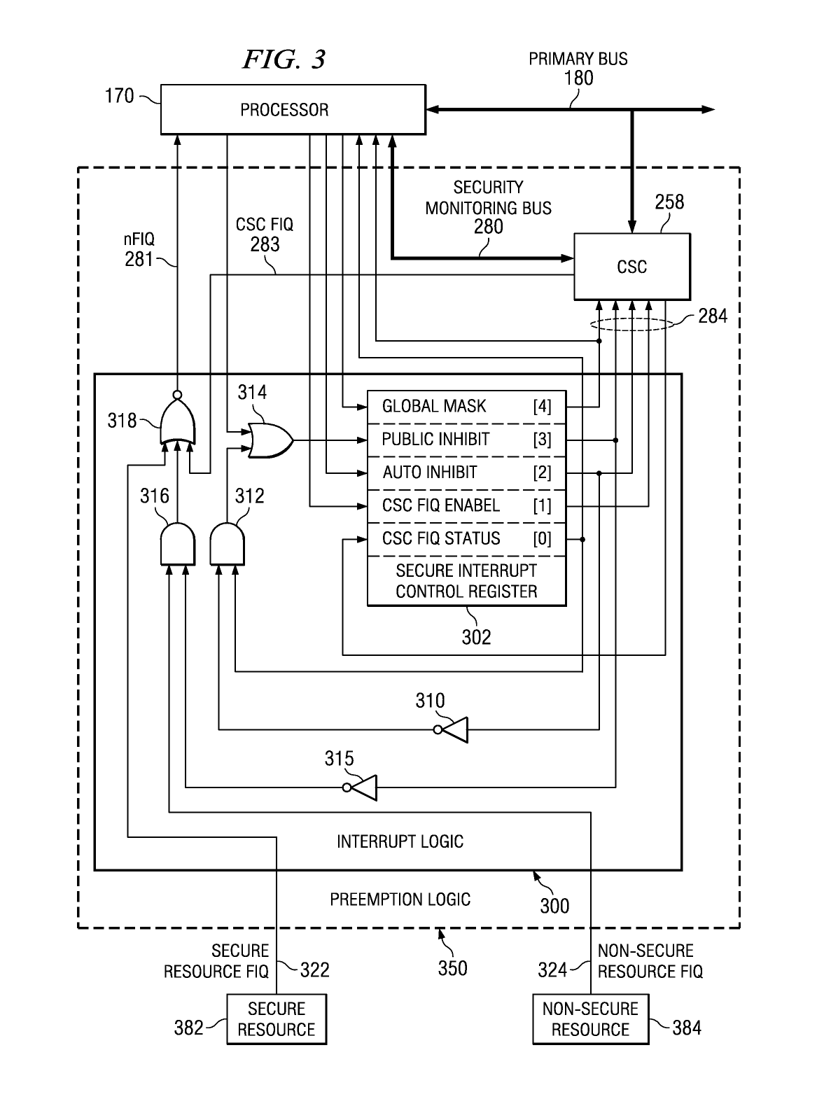

In at least some illustrative embodiments, interrupt logic 300 allows nFIQ assertions by non-secure resources to be preemptively masked and unmasked, without similar masking and/or unmasking of interrupt assertions initiated by secure resources. This capability is implemented such that nFIQ assertions initiated by non-secure resources are maskable by non-secure programs executing on processor 170, even when such assertions cannot similarly be masked by the same non-secure programs using a control register within processor 170. FIG. 3 shows an illustrative embodiment that implements such a masking scheme. Core security controller 258, which couples to processor 170 via security monitor bus 280, monitors signals on security monitor bus 280 to identify when a non-secure program executing on processor 170 requires masking of nFIQ assertions initiated by non-secure resources.

The signals provided by security monitor bus 280 may comprise a variety of status bits that allow the core security controller 258 to determine such things as the current security mode of the processor 170, whether the processor 170 is configured to provide secure processing of nFIQ assertions, and whether an attempt to mask nFIQ assertions (or all processor interrupt assertions, including nFIQ assertions) has been initiated. In at least some illustrative embodiments an ARM® series processor core is used, and the monitored signals include bits from the current processor status register (CPSR; not shown), such as the interrupt mask bit (I-bit), fast interrupt mask bit (F-bit), the CPSR mode bits, the CPSR non-secure bit, as well as configuration control bits within the status and control register (SCR; not shown), such as the bits controlling whether processor 170 is configured to provide secure processing of nFIQ assertions. Other embodiments may include different processor cores and/or different bits and signals that are driven onto the security monitor bus 280, and all such embodiments are intended to be within the scope of this disclosure.

Continuing to refer to the illustrative embodiment of FIG. 3, core security controller 258 also couples to interrupt logic 300 via mask signal bus 284, which is used to transfer signals between core security controller 258 and interrupt logic 300, and which together form preemption logic 350. Processor 170 also couples to and interacts with interrupt logic 300. Interrupt logic 300 comprises secure interrupt control register 302, which drives and/or receives the signals of the mask signal bus 284. The bits of interrupt control register 302 include: the CSC FIQ status bit (bit 0), which is set and reset by the core security controller 258, indicates to processor 170 when non-secure masking of the FIQ interrupt is required, and provides non-secure FIQ masking under at least some circumstances; the CSC FIQ enable bit (bit 1), which is set and reset by processor 170 and controls enabling and disabling of non-secure FIQ masking by the core security controller 258; the auto inhibit bit (bit 2), which is set and reset by processor 170 and indicates to the core security controller whether automatic preemptive FIQ masking and unmasking is enabled; the public inhibit (non-secure interrupt mask) bit (bit 3), which is set and reset by processor 170 and controls whether non-secure FIQ are masked (inhibited); and the global mask bit (bit 4), which is set and reset by either processor 170 or the core security controller 258 and initiates an express masking of all FIQ interrupt assertions (both secure and non-secure).

Interrupt logic 300 also includes combinatorial logic gates 310-318. Logic gates 315-318 allow secure FIQ signals, such as secure resource FIQ signal 322 generated by secure resource 382, to cause the nFIQ signal 281 to be asserted, regardless of the state of the various bits of secure interrupt control register 302. Combinatorial logic gates 315-318 further provide the ability to mask non-secure FIQ signals, such as non-secure resource signal 324 generated by non-secure resource 384, and thus to prevent non-secure resources from causing assertions of nFIQ signal 281. The masking of non-secure FIQ signals is controlled by the public inhibit bit of secure interrupt control register 302. Combinatorial logic gates 310-314 allow the state of the public inhibit bit of secure interrupt control register 302 to be controlled by either processor 170 or selectively by the CSC FIQ status bit, as described below. Although all of these combinatorial logic gates are shown in FIG. 3 as hardware logic gates, other embodiments combining different hardware elements, state machines and/or software will become apparent those skilled in the art, and all such hardware, software and combinations are intended to be within the scope of the present disclosure.

In the illustrative embodiment of FIG. 3, at least one of the following four conditions may cause non-secure FIQ assertions to be masked: 1) the CPSR mode bits exported by processor 170 onto security monitor bus 280 indicate that the processor 170 has switched to the FIQ mode; 2) the processor 170 is attempting to set (mask) or clear (unmask) the CPSR I-bit and/or F-bit; 3) software executing on processor 170 causes the processor to set or clear the public inhibit bit of secure interrupt control register 302; or 4) the global mask bit of secure interrupt control register 302 is set or cleared. It should be noted that in the illustrative embodiment described, detection of the first two of the four listed conditions is further conditioned upon whether non-secure FIQ assertion masking is enabled (i.e., the CSC FIQ enable bit of secure interrupt control register 302 is set. Further, masking of non-secure FIQ assertions may be configured to take place without the intervention of processor 170 (automatic mode) or with the intervention of processor 170 (manual mode), based upon the state of the auto inhibit bit of secure interrupt control register 302.

The core security controller 258 includes a state machine (not shown) that monitors the security monitor bus 280 and detects when conditions on the bus require that non-secure FIQ assertions be masked as described above. The state machine responds by selectively setting and clearing bits within the secure interrupt control register 302. The particular bits set or cleared, and the conditions under which such bits are set or cleared, depends in part on the setting of other bits within the secure interrupt control register 302, some of which may be set or cleared by the core security controller 258, the processor 170, or both.

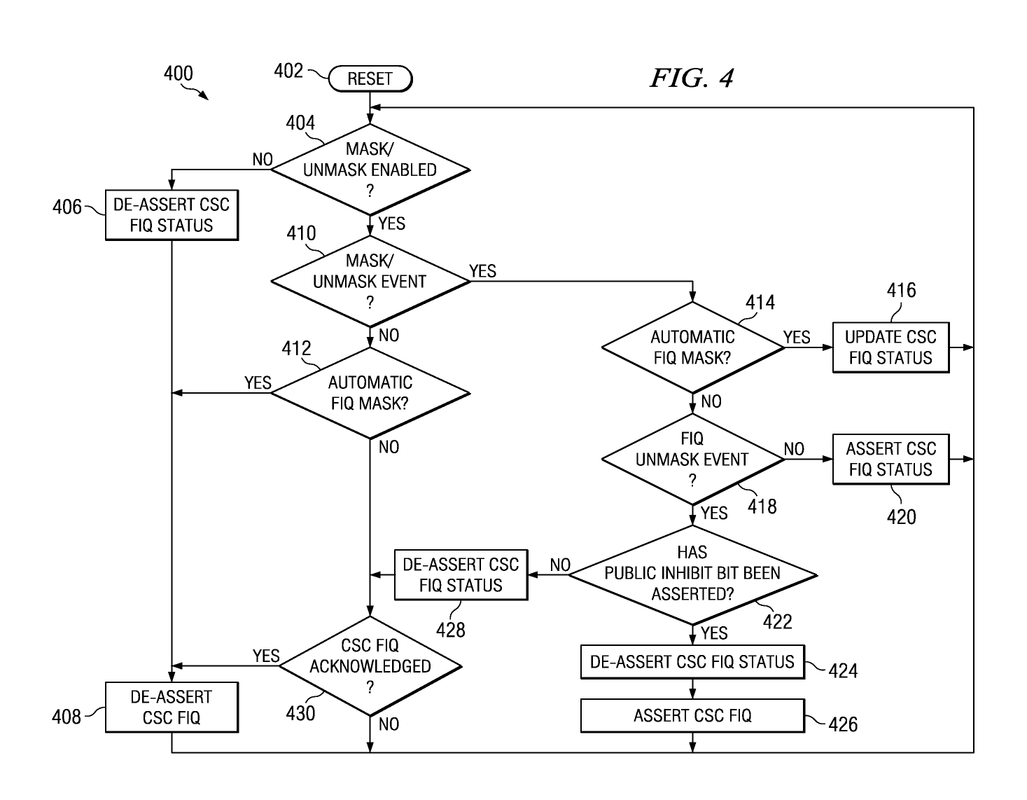

FIG. 4 shows a method 400 illustrating operation of the state machine within core security controller 258 of FIG. 3. Although the actions of this method are presented and described serially, one of ordinary skill in the art will appreciate that the order may differ and/or some of the actions may occur in parallel. The method begins with a reset of the state machine (block 402), after which the state machine loops continuously through the method shown. If preemptive non-secure FIQ masking and unmasking has not been enabled (block 404), both the CSC FIQ status bit of secure interrupt control register 302 and CSC FIQ signal 283 (FIG. 3) are maintained in a de-asserted state (blocks 406 and 408). The public inhibit bit will also subsequently be maintained in a de-asserted state (not shown in FIG. 4) as a consequence of the de-assertion of the CSC FIQ status bit, either automatically by the hardware, or manually by an interrupt service routine executing on processor 170, as described below. In the illustrative embodiment of FIG. 3, enabling and disabling of preemptive non-secure FIQ masking and unmasking is controlled by the CSC FIQ enable bit of secure interrupt control register 302. If the CSC FIQ enable bit is asserted (set in the embodiment shown), preemptive masking and unmasking is enabled.

Continuing to refer to both FIGS. 3 and 4, if preemptive masking and unmasking is enabled, the state machine checks to determine if a mask or unmask event has taken place (block 410). If no mask or unmask event is detected, and automatic preemptive FIQ masking and unmasking is enabled (block 412), CSC FIQ signal 283 is de-asserted (block 408) and the state machine begins another cycle through the method 400 starting with block 404. Similarly, if no mask or unmask event is detected in block 410, automatic preemptive FIQ masking and unmasking is disabled (block 412), and an assertion of CSC FIQ signal 283 has been acknowledged (block 430), CSC FIQ signal 283 is de-asserted (block 408) and another cycle begins with block 404. If no mask or unmask event is detected in block 410, automatic preemptive FIQ masking and unmasking is disabled (block 412), but an assertion of CSC FIQ signal 283 has not been acknowledged, another cycle begins at block 404 without modifying the state of CSC FIQ signal 283.

Referring again to block 410, if a mask or unmask event is detected, and If automatic preemptive FIQ masking and unmasking is enabled (block 414), core security controller 258 updates the CSC FIQ status bit of secure interrupt control register 302 (block 416) to reflect the event detected (asserted for a mask event, de-asserted for an unmask event). The state of the public inhibit bit of secure interrupt control register 302 is automatically updated by hardware within interrupt logic 300 (when automatic preemptive masking and unmasking is enabled) to reflect the state of the CSC FIQ status bit. Thus, non-secure assertions of nFIQ signal 281 are accordingly masked or unmasked.

When the auto inhibit bit is asserted (i.e., set in the embodiment described), automatic preemptive FIQ masking and unmasking is not enabled, configuring the core security controller to operate in a manual preemptive masking and unmasking mode (manual mode). When in manual mode, non-secure nFIQ assertions are not automatically preemptively masked or unmasked. Instead, the CSC FIQ status bit is set or cleared (reflecting a mask or unmask operation), and nFIQ signal 281 is subsequently asserted. The assertion of nFIQ signal 281 may be initiated by a system resource (secure or non-secure) or by an assertion of CSC FIQ signal 283 (initiated by core security controller 258). The assertion of nFIQ signal 281 causes processor 170 to enter a monitor mode of operation and to execute an FIQ interrupt service routine. The FIQ interrupt service routine then sets or clears the public inhibit bit of secure interrupt control register 302 to mask or unmask non-secure nFIQ interrupt assertions. The state of the public inhibit bit is set by the FIQ interrupt service routine to a state matching the state of the CSC FIQ status bit of the secure interrupt control register 302.

For example, if the CSC FIQ status bit has been set by core security controller 258 in response to a mask operation, a subsequent assertion of nFIQ signal 281 initiated by a non-secure resource will result in a masking of the underlying assertion of non-secure resource FIQ signal 324. The FIQ interrupt service routine does not issue a call to the non-secure interrupt service routine associated with the non-secure resource FIQ, as the state of the CSC FIQ status bit indicates that assertions of nFIQ signal 281 that are initiated by non-secure resource 384 are masked. The FIQ interrupt service routine will also assert (set) the public inhibit bit, masking further non-secure assertions of the nFIQ signal 281. Because subsequent non-secure assertions of nFIQ signal 281 are masked following the first assertion, core security controller 258, upon detecting an unmask event while in manual mode, clears the CSC FIQ status bit and asserts CSC FIQ signal 283, causing an assertion of nFIQ signal 281. This causes the FIQ interrupt service routine to clear the public inhibit bit and thus to unmask non-secure assertions of nFIQ signal 281.

Returning to FIG. 4, if automatic preemptive FIQ masking and unmasking is not enabled (block 414), the state machine checks to determine if the detected event is an FIQ unmask event (block 418). If the detected event is not an FIQ unmask event (i.e., is a mask event), the CSC FIQ status bit is asserted (block 420), and another cycle through the method 400 is initiated (block 404). It should be noted that when the auto inhibit bit is set (automatic preemptive masking not enabled), the FIQ status bit can no longer preemptively mask non-secure FIQ assertions by automatically updating the public inhibit bit; only the processor can update the public inhibit bit and thus provide such preemptive masking when the state machine is operating in manual mode. As already described, when in manual mode the public inhibit bit is controlled by the interrupt service routine that is executed in response to assertion of nFIQ signal 281. Such an assertion of nFIQ signal 281 may be initiated either by a system resource (secure or non-secure), or by core security controller 258.

If the detected event is an FIQ unmask event (block 418), the state machine checks to determine if the public inhibit bit of secure interrupt control register 302 has been asserted (block 422), indicating that non-secure FIQ interrupt assertions are masked. If non-secure FIQ interrupt assertions are masked, the CSC FIQ status bit of secure interrupt control register 302 is de-asserted (block 424), and CSC FIQ signal 283 is asserted (block 426), generating an assertion of nFIQ signal 281. The assertion of nFIQ signal 281 triggers execution of the FIQ interrupt service routine as described above, wherein the public inhibit bit of secure interrupt control register 302 is de-asserted by the FIQ interrupt service routine, thus unmasking non-secure assertions of nFIQ signal 281.

If the public inhibit bit of secure interrupt control register 302 has not been asserted (block 422), indicating that non-secure FIQ interrupts are not masked, the CSC FIQ status bit is de-asserted (block 428). After de-assertion of the CSC FIQ status bit, if a previous assertion of CSC FIQ signal 283 has not been acknowledged (block 430), the state machine begins a new cycle of method 400 (block 404). If a previous assertion of CSC FIQ signal 283 has been acknowledged (block 430), CSC FIQ signal 283 is de-asserted (block 408) and the state machine begins a new cycle of method 400 (block 404). In at least some illustrative embodiments, core security controller 258 generates an acknowledgement of an assertion of CSC FIQ signal 283 in response to action by the interrupt service routine (e.g., when the interrupt service routine clears the public inhibit bit).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a processor; and
preemption logic coupled to the processor, the preemption logic capable of asserting an interrupt signal to the processor;
wherein if the processor is operating in a non-secure mode, the preemption logic preemptively inhibits a non-secure assertion of the interrupt signal in response to a mask event, and preemptively enables the non-secure assertion of the interrupt signal in response to an unmask event; and
wherein the preemptive inhibit and enable of the non-secure assertion of the interrupt signal do not affect a secure assertion of the interrupt signal.

2. The system of claim 1, wherein the processor does not participate in the preemptive inhibit nor in the preemptive enable of the non-secure assertion of the interrupt signal.

3. The system of claim 1, wherein the processor participates in the preemptive inhibit and the preemptive enable of the non-secure assertion of the interrupt signal.

4. The system of claim 3, wherein the participation of the processor comprises asserting a control bit to a first state in response to action by the preemption logic, and wherein asserting the control bit to the first state completes the preemptive inhibit of the non-secure assertion of the interrupt signal.

5. The system of claim 4, wherein the participation of the processor further comprises asserting the control bit to a second state different from the first state, and wherein asserting the control bit to the second state completes the preemptive enable of the non-secure assertion of the interrupt signal.

6. The system of claim 5, wherein the control bit is external to the processor.

7. The system of claim 1,
wherein asserting an enable bit to a first state allows the preemption logic to preemptively inhibit and preemptively enable non-secure assertions of the interrupt signal; and
wherein asserting the enable bit to a second state different from the first state prevents the preemption logic from preemptively inhibiting and preemptively enabling non-secure assertions of the interrupt signal.

8. The system of claim 7, wherein the enable bit is external to the processor.

9. The system of claim 1, wherein the system is a system-on-a-chip.

10. The system of claim 1, wherein the preemption logic comprises a state machine that controls operation of the preemption logic.

11. A method, comprising:
performing a first operation on a processor that results in an interrupt mask event;
preventing non-secure interrupt assertions from reaching the processor in response to detecting the interrupt mask event, if the processor is operating in a non-secure mode; and
allowing the processor to mask both secure and non-secure interrupt assertions, if the processor is operating in a secure mode.

12. The method of claim 11, wherein the interrupt mask event comprises at least one of:
asserting a processor interrupt bit mask while in the non-secure mode;
asserting a non-secure interrupt mask bit that is not part of an interrupt control register of the processor;
asserting a global interrupt mask bit that is not part of the interrupt control register of the processor; and
causing the processor to enter a mode of operation associated with an interrupt assertion after asserting a global status bit.

13. The method of claim 11, further comprising:
performing a second operation that results in an interrupt unmask event; and
allowing the non-secure interrupt assertions to reach the processor in response to detecting the interrupt unmask event, if the processor is operating in a non-secure mode; and
allowing the processor to unmask both secure and non-secure interrupt assertions, if the processor is operating in a secure mode.

14. The method of claim 13, wherein the interrupt unmask event comprises at least one of:
de-asserting a processor interrupt bit mask while in the non-secure mode;
de-asserting a non-secure interrupt mask bit that is not part of an interrupt control register of the processor;
de-asserting a global interrupt mask bit that is not part of the interrupt control register of the processor; and
causing the processor to enter a mode of operation associated with an interrupt assertion after de-asserting a global status bit.

15. The method of claim 13, wherein preventing and allowing non-secure interrupt assertions from reaching the processor do not comprise action by the processor.

16. The method of claim 13, wherein preventing and allowing non-secure interrupt assertions from reaching the processor comprise action by the processor.

17. The method of claim 16, wherein action by the processor that is a part of preventing non-secure interrupt assertions from reaching the processor comprises executing code that sets an interrupt inhibit bit to a first state, and wherein the interrupt inhibit bit is not part of an interrupt control register of the processor.

18. The method of claim 17, wherein action by the processor that is a part of allowing non-secure interrupt assertions to reach the processor comprises executing code that sets the interrupt inhibit bit to a second state different from the first state.

19. Interrupt preemption logic, comprising:
a controller configured to communicate with a processor, and configured to detect masking and unmasking events initiated by the processor when the processor operates in a non-secure mode; and
interrupt processing logic coupled to the controller, the interrupt processing logic configured to selectively forward a non-secure assertion of an interrupt signal to the processor without affecting a secure assertion of the interrupt signal.

20. The interrupt preemption logic of claim 19, wherein the controller is further configured to cause the interrupt processing logic to forward the non-secure assertion of the interrupt signal to the processor when an unmasking event is detected.

21. The interrupt preemption logic of claim 19, wherein the controller is further configured to cause the interrupt processing logic to prevent the non-secure assertion of the interrupt signal from being forwarded to the processor when a masking event is detected.

22. The interrupt preemption logic of claim 19, wherein the controller is further configured to cause the interrupt processing logic to forward and prevent forwarding of non-secure assertions of the interrupt signal without requiring intervention by the processor.

23. The interrupt preemption logic of claim 19, wherein the controller is further configured to cause the processor to cause the interrupt processing logic to forward and prevent forwarding of non-secure assertions of the interrupt signal.

24. The interrupt preemption logic of claim 19, wherein the unmasking event comprises at least one of:
de-asserting a processor interrupt bit mask while the processor is in the non-secure mode;
de-asserting a non-secure interrupt mask bit that is not part of an interrupt control register of the processor;
de-asserting a global interrupt mask bit that is not part of the interrupt control register of the processor; and
causing the processor to enter a mode of operation associated with an assertion of the interrupt signal after clearing a global status bit.

25. The interrupt preemption logic of claim 19, wherein the masking event comprises at least one of:
asserting a processor interrupt bit mask while the processor is in the non-secure mode;
asserting a non-secure interrupt mask bit that is not part of an interrupt control register of the processor;
asserting a global interrupt mask bit that is not part of the interrupt control register of the processor; and
causing the processor to enter a mode of operation associated with an assertion of the interrupt signal after asserting a global status bit.
